(19) United States
(12) Patent Application Publication
(10) Pub. No.: US 2026/0179570 A1
(43) Pub. Date: Jun. 25, 2026

(54) DISPLAY DEVICE

(71) Applicant: Sharp Display Technology Corporation, Kameyama City, Mie (JP)

(72) Inventors: Nobuyuki TAYA, Kameyama City, Mie (JP); Makoto YOKOYAMA, Kameyama City, Mie (JP)

(21) Appl. No.: 19/127,467

(22) PCT Filed: Nov. 15, 2022
(86) PCT No.: PCT/JP2022/042377

§ 371 Date: May 6, 2025

(51) Int. Cl. G09G 3/3275; G09G 3/00; G09G 3/20; G09G 3/3266; G09G 3/36

(52) U.S. Cl. CPC G09G 3/3275; G09G 3/006; G09G 3/2003; G09G 3/3266; G09G 3/3648; G09G 3/3677

(57) ABSTRACT

A display device includes a plurality of scanning signal lines, a plurality of data signal lines each of which intersects with the plurality of scanning signal lines, a display region provided with a plurality of pixel circuits, a data-side drive circuit, a first dummy scanning signal line provided between the display region and the data-side drive circuit and intersecting with at least one or some of the plurality of data signal lines without including the pixel circuits, a first inspection terminal electrically connected to the first dummy scanning signal line, and a first scanning-side drive circuit including a plurality of unit circuits configured to sequentially output scanning signals to the plurality of scanning signal lines and the first dummy scanning signal line.

### TECHNICAL FIELD

The disclosure relates to a display device.

### BACKGROUND ART

PTL 1 describes a display device in which a unit circuit for evaluating an output pulse is provided at the final stage of a plurality of unit circuits (shift registers) to check the operation of a scanning-side drive circuit (gate drive circuit), and an inspection terminal and a plurality of dummy pixel circuits each of which is obtained by removing only portions for display (for example, a lower electrode, a liquid crystal layer, and an upper electrode) from the configuration of a pixel circuit provided in a display region are electrically connected to a dummy scanning signal line connected to an output terminal of the unit circuit for evaluating the output pulse.

### CITATION LIST

### Patent Literature

PTL 1: JP 2010-249889 A

### SUMMARY

### Technical Problem

In recent years, in the field related to display devices, in order to secure a wider display region, research has been actively conducted to achieve frame narrowing which means making a frame region that is a peripheral portion of the display region narrower. However, in the case of the display device described in PTL 1, the dummy scanning signal line connected to the output terminal of the unit circuit (shift register) for evaluating the output pulse is electrically connected to the inspection terminal and the plurality of dummy pixel circuits each of which is obtained by removing only portions for display (for example, the lower electrode, the liquid crystal layer, and the upper electrode) from the configuration of the pixel circuit provided in the display region. That is, in the case of the display device described in PTL 1, since the dummy scanning signal line including the plurality of dummy pixel circuits is provided, the size of a region in which the dummy scanning signal line and the plurality of dummy pixel circuits are provided is relatively large, which causes a problem that the size of the region becomes a major cause of preventing the frame narrowing of the display device.

An aspect of the disclosure has been made in view of the above problems, and an object thereof is to provide a display device that allows operation check of a scanning-side drive circuit and that achieves frame narrowing of the display device.

### Solution to Problem

In order to solve the above problems, a display device according to the disclosure includes
a plurality of scanning signal lines,
a plurality of data signal lines each of which intersects with the plurality of scanning signal lines,
a plurality of pixel circuits provided at a plurality of locations where the scanning signal lines and the data signal lines intersect with each other,
a display region provided with the plurality of pixel circuits,
a data-side drive circuit configured to output a data signal to each of the plurality of data signal lines,
a first dummy scanning signal line provided between the display region and the data-side drive circuit, the first dummy scanning signal line intersecting with at least one or some data signal lines of the plurality of data signal lines without including any of the plurality of pixel circuits,
a first inspection terminal electrically connected to the first dummy scanning signal line, and
a first scanning-side drive circuit including a plurality of unit circuits configured to sequentially output a scanning signal to at least one or some scanning signal lines of the plurality of scanning signal lines and the first dummy scanning signal line.

### Advantageous Effects of Disclosure

An aspect of the disclosure can provide a display device capable of allowing operation check of a scanning-side drive circuit and achieving frame narrowing of the display device.

### BRIEF DESCRIPTION OF DRAWINGS

FIG. 1 is a plan view illustrating a schematic configuration of a display device according to a first embodiment.

FIG. 2 is a circuit diagram illustrating a pixel circuit provided in a display region of the display device according to the first embodiment illustrated in FIG. 1.

FIG. 3 is a diagram illustrating an example of another display device in which, to a first dummy scanning signal line provided in the display device according to the first embodiment as illustrated in FIG. 1, a plurality of first dummy transistors each of which includes a gate electrode electrically connected to the first dummy scanning signal line are further provided to the first dummy scanning signal line.

FIG. 4 is a diagram illustrating a schematic configuration of the first dummy transistor illustrated in FIG. 3.

FIG. 5 is a graph illustrating a simulation waveform of a scanning signal detected from a scanning signal line provided in a display region of each display device illustrated in FIG. 1 and FIG. 3, a simulation waveform of a scanning signal detected from a first inspection terminal of the display device illustrated in FIG. 1, a simulation waveform of a scanning signal detected from a first inspection terminal of the display device illustrated in FIG. 3, and a simulation waveform of a scanning signal detected from a first inspection terminal of a display device of a comparative example illustrated in FIG. 11.

FIG. 6 is a diagram illustrating a part of a display device according to a second embodiment, and the display device is provided with a plurality of another type of first dummy transistors each of which includes a gate electrode electrically connected to a first dummy scanning signal line.

FIG. 7 is a diagram illustrating a schematic configuration of the first dummy transistors illustrated in FIG. 6.

FIG. 8 is a circuit diagram illustrating a unit circuit included in a scanning-side drive circuit provided in a display device according to a third embodiment illustrated in FIG. 10.

FIG. 9 is a circuit diagram illustrating a pixel circuit provided in a display region of the display device according to the third embodiment illustrated in FIG. 10.

FIG. 10 is a diagram illustrating a part of the display device according to the third embodiment.

FIG. 11 is a plan view illustrating a schematic configuration of a display device according to a first comparative example.

FIG. 12 is a plan view illustrating a schematic configuration of a display device according to a fourth embodiment.

FIG. 13 is a plan view illustrating a schematic configuration of a display device according to a second comparative example.

### DESCRIPTION OF EMBODIMENTS

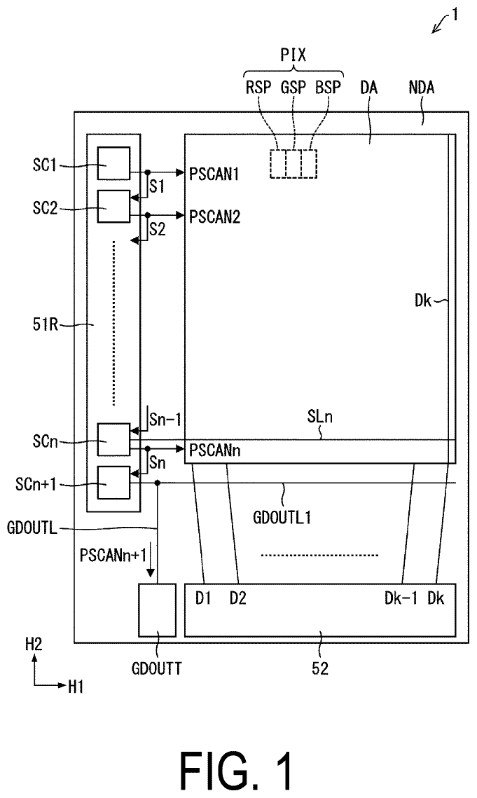

Embodiments of the disclosure will be described below with reference to FIG. 1 to FIG. 13. Hereinafter, for convenience of description, configurations having the same functions as those described in a specific embodiment are denoted by the same reference signs, and descriptions thereof may be omitted.

### First Embodiment

FIG. 1 is a plan view illustrating a schematic configuration of a display device 1 according to a first embodiment.

The display device 1 illustrated in FIG. 1 includes a display region DA and a frame region NDA. In the display region DA, for example, a plurality of display units PIX each of which includes a red pixel RSP, a green pixel GSP, and a blue pixel BSP are provided. In the present embodiment, although an example in which the one display unit PIX includes the red pixel RSP, the green pixel GSP, and the blue pixel BSP will be described, the disclosure is not limited thereto. For example, the one display unit PIX may further include a pixel of another color in addition to the red pixel RSP, the green pixel GSP, and the blue pixel BSP. The frame region NDA is provided with a first scanning-side drive circuit 51R, a data-side drive circuit 52, a first dummy scanning signal line GDOUTL1 electrically connected to an output terminal of a unit circuit SCn+1 for evaluating an output pulse, which is the final stage of a plurality of unit circuits (shift registers) SC1 to SCn+1 provided in the first scanning-side drive circuit 51R, and a first inspection terminal GDOUTT electrically connected to the output terminal of the unit circuit SCn+1 for evaluating the output pulse and the first dummy scanning signal line GDOUTL1 through a lead-out wiring line GDOUTL.

As illustrated in FIG. 1, the display device 1 is provided with a plurality of scanning signal lines SLn (in FIG. 1, the scanning signal lines SL1 to SLn-1 are omitted and only the scanning signal line SLn is illustrated) and a plurality of data signal lines D1 to Dk (in FIG. 1, the data signal lines D1 to Dk-1 are omitted and only the data signal line Dk is illustrated in the display region DA).

The scanning signal line SLn extends along a first direction H1 illustrated in FIG. 1 and is electrically connected to an output terminal of the unit circuit SCn provided in the first scanning-side drive circuit 51R. The scanning signal lines SL1 to SLn-1 (not illustrated) are also formed similarly to the scanning signal line SLn. For example, the scanning signal line SL1 extends along the first direction H1 illustrated in FIG. 1 and is electrically connected to an output terminal of the unit circuit SC1 provided in the first scanning-side drive circuit 51R, and the scanning signal line SL2 extends along the first direction H1 illustrated in FIG. 1 and is electrically connected to an output terminal of the unit circuit SC2 provided in the first scanning-side drive circuit 51R.

Each of the plurality of data signal lines D1 to Dk extending from the data-side drive circuit 52 along a second direction H2 illustrated in FIG. 1 intersects with the plurality of scanning signal lines SLn in the display region DA.

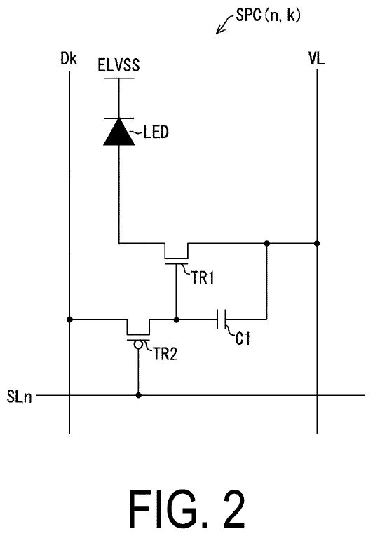

FIG. 2 is a circuit diagram illustrating a pixel circuit SPC(n, k) provided at each of a plurality of locations where the scanning signal lines SL1 to SLn and the data signal lines D1 to Dk provided in the display region DA of the display device 1 according to the first embodiment illustrated in FIG. 1 intersect with each other. Note that the pixel circuit SPC(n, k) illustrated in FIG. 2 is an example of the pixel circuit that can be included in the display device 1 according to the first embodiment, and the disclosure is not limited thereto. Note that n and k are natural numbers.

In the pixel circuit SPC(n, k), as illustrated in FIG. 2, including a light-emitting element LED provided in each of the pixels RSP, GSP, and BSP of the respective colors illustrated in FIG. 1, a drain electrode of a transistor TR1 serving as a drive transistor is electrically connected to an electrode (not illustrated) on one side of the light-emitting element LED, a gate electrode of the transistor TR1 is electrically connected to an electrode on one side of a holding capacitor C1 and a drain electrode of a transistor TR2 serving as a selecting transistor, and a source electrode of the transistor TR1 is electrically connected to an electrode on the other side of the holding capacitor C1 and an ELVDD wiring line VL that is supplied with a high-level power supply voltage ELVDD from a power source circuit (not illustrated). Note that an electrode on the other side of the light-emitting element LED is electrically connected to an ELVSS wiring line to which a low-level power supply voltage ELVSS is supplied from the power source circuit (not illustrated). Additionally, a source electrode of the transistor TR2 serving as the selecting transistor is electrically connected to the data signal line Dk that is supplied with a data signal output from the data-side drive circuit 52 illustrated in FIG. 1, a gate electrode of the transistor TR2 is electrically connected to the scanning signal line SLn that is supplied with a scanning signal output from the first scanning-side drive circuit 51R illustrated in FIG. 1, and the drain electrode of the transistor TR2 is electrically connected to the gate electrode of the transistor TR1 and the electrode on the one side of the holding capacitor C1.

The light-emitting element LED included in the pixel circuit SPC(n, k) may include, for example, a light-emitting layer including quantum dots or an organic light-emitting layer.

In the present embodiment, as illustrated in FIG. 2, a case where the transistor (first transistor) TR2 serving as the selecting transistor and including the gate electrode electrically connected to the scanning signal line SLn is a P-type transistor will be described as an example, but the disclosure is not limited thereto and the transistor (first transistor) TR2 serving as the selecting transistor and including the gate electrode electrically connected to the scanning signal line SLn may be an N-type transistor.

As described above, in the present embodiment, since the pixel circuit SPC(n, k) includes the transistor (first transistor) TR2 that is the P-type transistor including the gate electrode electrically connected to the scanning signal line SLn, each of the plurality of unit circuits SC1 to SCn+1 included in the first scanning-side drive circuit 51R illustrated in FIG. 1 sequentially outputs scanning signals (first scanning signals) PSCAN1 to PSCANn+1 that are a Low Active signal for controlling the P-type transistors in a direction from the unit circuit SC1 to the unit circuit SCn+1. The unit circuit SC1 outputs the scanning signal (first scanning signal) PSCAN1, which is the Low Active signal for controlling the P-type transistor, from the output terminal to the scanning signal line SL1 (not illustrated), and outputs the scanning signal (first scanning signal) PSCAN1 to the unit circuit SC2 as a set signal S1. The unit circuit SC2 receives the set signal S1 from the unit circuit SC1, and in accordance with the timing of the reception of the set signal, outputs the scanning signal (first scanning signal) PSCAN2, which is the Low Active signal for controlling the P-type transistor, from the output terminal to the scanning signal line SL2 (not illustrated), and outputs the scanning signal (first scanning signal) PSCAN2 to the unit circuit SC3 as a set signal S2. Each of the unit circuits SC3 to SCn+1 is also driven in a similar manner.

The scanning signal (first scanning signal) PSCAN1 from the first scanning-side drive circuit 51R is supplied to the scanning signal line SL1, the scanning signal (first scanning signal) PSCAN2 from the first scanning-side drive circuit 51R is supplied to the scanning signal line SL2, the scanning signal (first scanning signal) PSCANn from the first scanning-side drive circuit 51R is supplied to the scanning signal line SLn, the scanning signal (first scanning signal) PSCANn+1 from the first scanning-side drive circuit 51R is supplied to the first dummy scanning signal line GDOUTL1, and scanning signals (first scanning signals) PSCAN3 to PSCANn-1 from the first scanning-side drive circuit 51R are respectively supplied to the scanning signal lines SL3 to SLn-1.

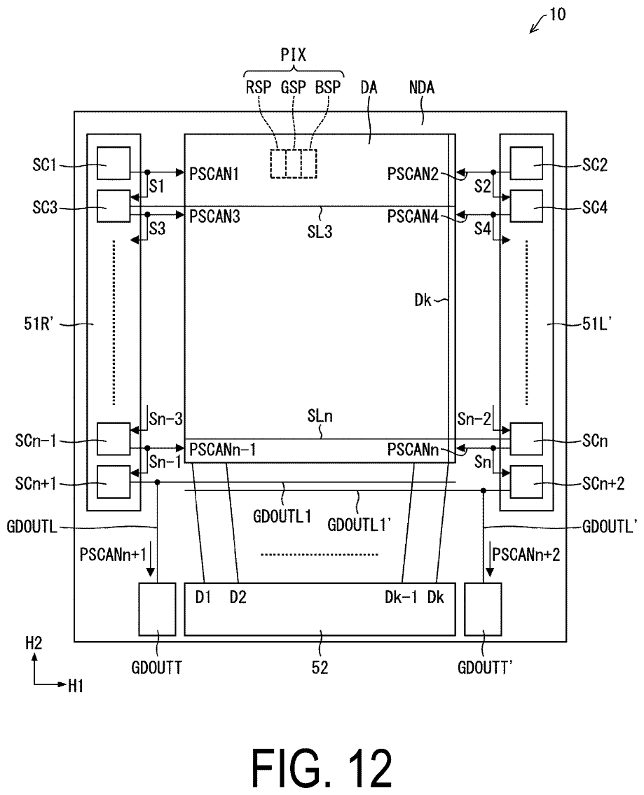

In the present embodiment, as described above, the case where one scanning-side drive circuit (first scanning-side drive circuit 51R) is provided only on one side of the plurality of scanning signal lines SL1 to SLn, for example, only on the left side thereof has been described as an example, but the disclosure is not limited thereto. For example, one scanning-side drive circuit may be provided only on the right side of the plurality of scanning signal lines SL1 to SLn, or a case may be applicable in which two scanning-side drive circuits (see first scanning-side drive circuits 51R′ and 51L′ in FIG. 12) are provided on both ends of the plurality of scanning signal lines SL1 to SLn, one of the two scanning-side drive circuits may sequentially supply the scanning signals (first scanning signals) to the odd-numbered scanning signal lines SL1, SL3, . . . , and SLn-1, and the other of the two scanning-side drive circuits may sequentially supply the scanning signals (first scanning signals) to the even-numbered scanning signal lines SL2, SL4, . . . , and SLn, as in a fourth embodiment, which will be described later.

As illustrated in FIG. 1, in the display device 1 according to the present embodiment, the first dummy scanning signal line GDOUTL1 intersecting with each of the plurality of data signal lines D1 to Dk is provided between the display region DA and the data-side drive circuit 52. The first dummy scanning signal line GDOUTL1 is electrically connected to the output terminal of the unit circuit SCn+1 for evaluating an output pulse, which is the final stage of the plurality of unit circuits SC1 to SCn+1 included in the first scanning-side drive circuit 51R. Then, the scanning signal (first scanning signal) PSCANn+1, which is an output pulse for evaluation, can be detected from the first inspection terminal GDOUTT electrically connected to the output terminal of the unit circuit SCn+1 for evaluating the output pulse and the first dummy scanning signal line GDOUTL1 through the lead-out wiring line GDOUTL.

In the display device 1 of the present embodiment, the first dummy scanning signal line GDOUTL1 is formed along the plurality of scanning signal lines SL1 to SLn, that is, along the first direction H1 illustrated in FIG. 1. In addition, the first dummy scanning signal line GDOUTL1 and each of the plurality of scanning signal lines SL1 to SLn are made of the same material and are formed with the same thickness and the same line width.

In the display device 1 of the present embodiment, a size of the display region DA is designed to be as large as possible and a size of the frame region NDA is designed to be as small as possible, and in actual dimensions, a width of the display region DA in the first direction H1 illustrated in FIG. 1 is significantly larger than a width between the display region DA and the first scanning-side drive circuit 51R. Thus, when the first dummy scanning signal line GDOUTL1 is provided along the plurality of scanning signal lines SL1 to SLn so as to intersect with the plurality of data signal lines D1 to Dk as in the present embodiment, a wiring length of the first dummy scanning signal line GDOUTL1 is substantially equal to a wiring length of each of the plurality of scanning signal lines SL1 to SLn.

As described above, the wiring length of the first dummy scanning signal line GDOUTL1 is substantially equal to the wiring length of each of the plurality of scanning signal lines SL1 to SLn, and the first dummy scanning signal line GDOUTL1 and each of the plurality of scanning signal lines SL1 to SLn are made of the same material and formed with the same thickness and the same line width. Thus, the first dummy scanning signal line GDOUTL1 has a resistance and a wiring fringe capacitance equivalent to those of each of the plurality of scanning signal lines SL1 to SLn. In addition, since the first dummy scanning signal line GDOUTL1 is provided so as to intersect with each of the plurality of data signal lines D1 to Dk, the first dummy scanning signal line GDOUTL1 has a cross capacitance (capacitance generated at a position where the scanning signal line or the first dummy scanning signal line intersects with the data signal line) equivalent to that of each of the plurality of scanning signal lines SL1 to SLn.

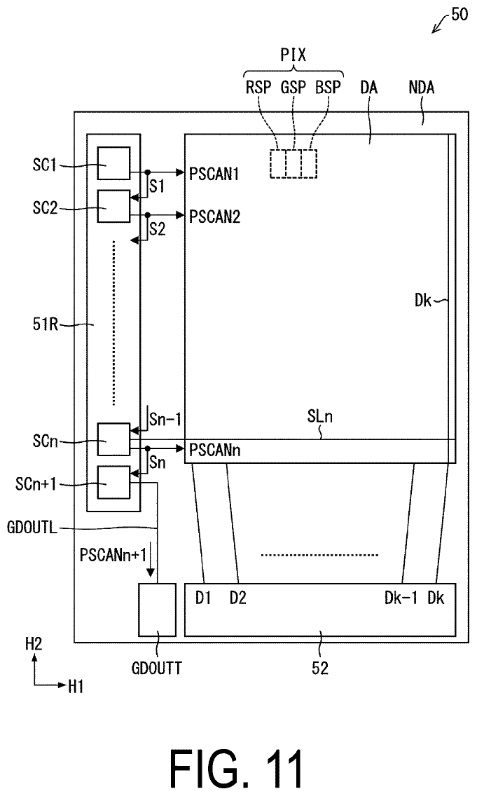

FIG. 11 is a plan view illustrating a schematic configuration of a display device 50 according to a first comparative example.

The display device 50 illustrated in FIG. 11 is different from the above-described display device 1 illustrated in FIG. 1 in that the first dummy scanning signal line GDOUTL1 is not provided.

As illustrated in FIG. 11, in the display device 50, the output terminal of the unit circuit SCn+1 for evaluating the output pulse, which is the final stage of the plurality of unit circuits SC1 to SCn+1 provided in the first scanning-side drive circuit 51R, is electrically connected to the first inspection terminal GDOUTT through the lead-out wiring line GDOUTL. Thus, in the case of the display device 50 of the first comparative example, frame narrowing of the display device 50 can be achieved, but a waveform of the scanning signal (first scanning signal) PSCANn+1, which is an output pulse for evaluation that is detected from the first inspection terminal GDOUTT, is significantly different from waveforms of the scanning signals (first scanning signals) PSCAN1 to PSCANn that can be detected from the scanning signal lines SL1 to SLn, which makes it difficult to check the operation of the first scanning-side drive circuit 51R.

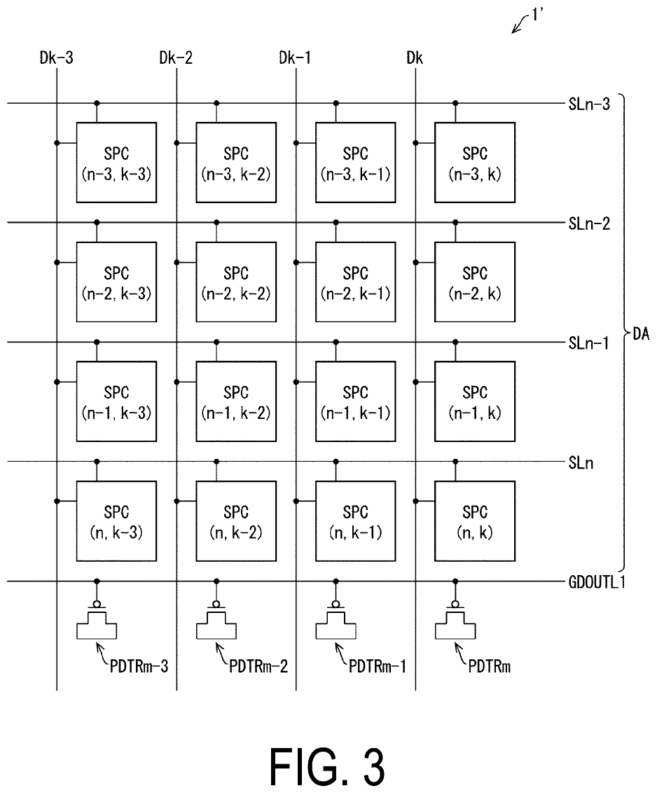

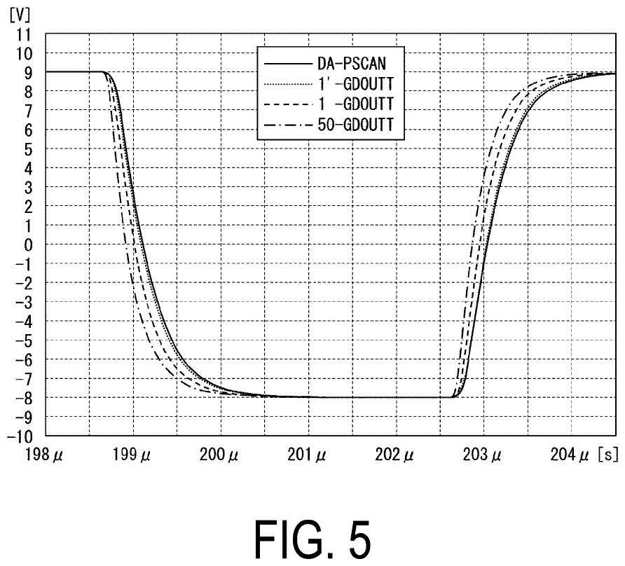

FIG. 5 is a graph illustrating simulation waveforms of scanning signals detected from the scanning signal lines SL1 to SLn provided in the display region DA of each of the display devices 1 and 1′ illustrated in FIG. 1 and FIG. 3, a simulation waveform of a scanning signal detected from the first inspection terminal GDOUTT of the display device 1 illustrated in FIG. 1, a simulation waveform of a scanning signal detected from the first inspection terminal GDOUTT of the display device 1′ illustrated in FIG. 3, and a simulation waveform of a scanning signal detected from the first inspection terminal GDOUTT of the display device 50 of the first comparative example illustrated in FIG. 11.

As illustrated in FIG. 5, the simulation waveform DA-PSCAN of the scanning signals detected from the scanning signal lines SL1 to SLn provided in the display region DA of the display device 1 illustrated in FIG. 1 is significantly different from the simulation waveform 50-GDOUTT of the scanning signal detected from the first inspection terminal GDOUTT of the display device 50 according to the first comparative example illustrated in FIG. 11. That is, the distortion of the simulation waveform DA-PSCAN is significantly different from the distortion of the simulation waveform 50-GDOUTT.

On the other hand, as illustrated in FIG. 5, the simulation waveform 1-GDOUTT of the scanning signal detected from the first inspection terminal GDOUTT of the display device 1 illustrated in FIG. 1 is close to the simulation waveform DA-PSCAN of the scanning signals detected from the scanning signal lines SL1 to SLn provided in the display region DA of the display device 1 illustrated in FIG. 1, compared with the simulation waveform 50-GDOUTT of the scanning signal detected from the first inspection terminal GDOUTT of the display device 50 of the first comparative example illustrated in FIG. 11. That is, the distortion of the simulation waveform 1-GDOUTT is similar to the distortion of the simulation waveform DA-PSCAN as compared with the distortion of the simulation waveform 50-GDOUTT.

Thus, according to the display device 1 illustrated in FIG. 1, since a dummy pixel circuit is not provided in the frame region NDA, frame narrowing can be achieved. Note that the dummy pixel circuit means, for example, a circuit obtained by removing only a portion of the light-emitting element LED from the pixel circuit SPC(n, k) illustrated in FIG. 2. Additionally, since the first dummy scanning signal line GDOUTL1 provided in the display device 1 has a resistance, a wiring fringe capacitance, and a cross capacitance equivalent to those of each of the plurality of scanning signal lines SL1 to SLn, when display failure occurs, feedback for improving the operation of the first scanning-side drive circuit 51R, in order to investigate the cause of the display failure in the display device 1 or to improve the display quality thereof, can be performed with high accuracy by monitoring the waveform of the scanning signal (first scanning signal) PSCANn+1 that is an output pulse for evaluation by using the first inspection terminal GDOUTT.

As described above, in the present embodiment, the case where the wiring length of the first dummy scanning signal line GDOUTL1 is substantially equal to the wiring length of each of the plurality of scanning signal lines SL1 to SLn, and the first dummy scanning signal line GDOUTL1 and each of the plurality of scanning signal lines SL1 to SLn are made of the same material in the same layer with the same thickness and the same line width has been described as an example, but the disclosure is not limited thereto.

For example, the wiring length of the first dummy scanning signal line GDOUTL1 may be different from the wiring length of each of the plurality of scanning signal lines SL1 to SLn as long as the resistance, the wiring fringe capacitance, and the cross capacitance of the first dummy scanning signal line GDOUTL1 can be brought close to the resistance, the wiring fringe capacitance, and the cross capacitance of each of the plurality of scanning signal lines SL1 to SLn. Additionally, the first dummy scanning signal line GDOUTL1 may be provided so as to intersect with at least one or some of the plurality of data signal lines D1 to Dk. In addition, the first dummy scanning signal line GDOUTL1 and each of the plurality of scanning signal lines SL1 to SLn may be made of different materials, and may be formed with different thicknesses and different line widths. Further, the first dummy scanning signal line GDOUTL1 does not need to be formed along the plurality of scanning signal lines SL1 to SLn. In the present embodiment, as described above, since the size of the frame region NDA is designed to be as small as possible, the width between the display region DA and the data-side drive circuit 52 illustrated in FIG. 1 is relatively narrow in actual dimensions, and even when the first dummy scanning signal line GDOUTL1 is not formed along the plurality of scanning signal lines SL1 to SLn, the frame narrowing of the display device 1 is not prevented.

FIG. 3 is a diagram illustrating an example of another display device l'in which a plurality of first dummy transistors PDTRm each of which includes a gate electrode electrically connected to the first dummy scanning signal line GDOUTL1 provided in the display device 1 according to the first embodiment illustrated in FIG. 1 are further provided to the first dummy scanning signal line GDOUTL1. Note that m is a natural number.

The display device 1′ illustrated in FIG. 3 is different from the display device 1 according to the first embodiment illustrated in FIG. 1 in that the plurality of first dummy transistors PDTRm each of which includes the gate electrode electrically connected to the first dummy scanning signal line GDOUTL1 are provided.

As illustrated in FIG. 2 and FIG. 3, each of the plurality of scanning signal lines SL1 to SLn is provided with k pixel circuits SPC(1, 1) to SPC(n, k) each of which includes the transistor (first transistor) TR2 including the gate electrode electrically connected to the corresponding scanning signal line, and in the present embodiment, the first dummy scanning signal line GDOUTL1 is provided with k first dummy transistors PDTRm each of which includes the gate electrode electrically connected to the first dummy scanning signal line GDOUTL1. The disclosure is not limited thereto, and the number of the first dummy transistors PDTRm that are provided to the first dummy scanning signal line GDOUTL1 and each of which includes the gate electrode electrically connected to the first dummy scanning signal line GDOUTL1 may be one or more and k or less.

According to the display device 1′ illustrated in FIG. 3, a transistor capacitance (capacitance formed at a portion where the gate electrode and the semiconductor layer overlap with each other) of the first dummy scanning signal line GDOUTL1 can be made close to a transistor capacitance of each of the plurality of scanning signal lines SL1 to SLn.

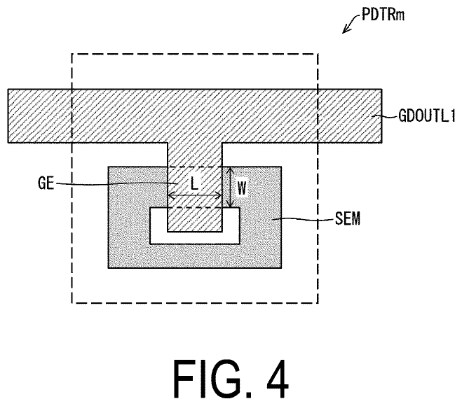

FIG. 4 is a diagram illustrating a schematic configuration of the first dummy transistor PDTRm illustrated in FIG. 3.

Each of the first dummy transistor PDTRm illustrated in FIG. 3 and FIG. 4 and the transistor (first transistor) TR2 included in the pixel circuit SPC(n, k) illustrated in FIG. 2 includes a semiconductor layer SEM made of the same material in the same shape and a gate electrode GE made of the same material in the same shape. That is, the first dummy transistor PDTRm illustrated in FIG. 3 and FIG. 4 and the transistor (first transistor) TR2 included in the pixel circuit SPC(n, k) illustrated in FIG. 2 have the same transistor capacitance, which is a capacitance formed at a portion where the semiconductor layer SEM and the gate electrode GE having a length L and a width W overlap with each other.

As illustrated in FIG. 5, the simulation waveform DA-PSCAN of the scanning signals detected from the scanning signal lines SL1 to SLn provided in the display region DA of the display devices 1 and 1′ respectively illustrated in FIG. 1 and FIG. 3 substantially coincides with the simulation waveform 1′-GDOUTT of the scanning signal detected from the first inspection terminal GDOUTT of the display device 1′ illustrated in FIG. 3. That is, the distortion of the simulation waveform DA-PSCAN and the distortion of the simulation waveform 1′-GDOUTT substantially coincide with each other.

Thus, according to the display device 1′ illustrated in FIG. 3, entirety of the dummy pixel circuits is not provided in the frame region NDA, but only the first dummy transistors PDTRm each of which includes the gate electrode GE electrically connected to the first dummy scanning signal line GDOUTL1 are provided, so that frame narrowing can be achieved. In addition, since the first dummy scanning signal line GDOUTL1 provided in the display device 1′ has the resistance, the wiring fringe capacitance, the cross capacitance, and the transistor capacitance equivalent to those of each of the plurality of scanning signal lines SL1 to SLn, when display failure occurs, the feedback for improving the operation of the first scanning-side drive circuit 51R, in order to investigate the cause of the display failure in the display device 1′ or to improve the display quality thereof, can be performed with high accuracy by monitoring the waveform of the scanning signal (first scanning signal) PSCANn+1 that is an output pulse for evaluation by using the first inspection terminal GDOUTT.

### Second Embodiment

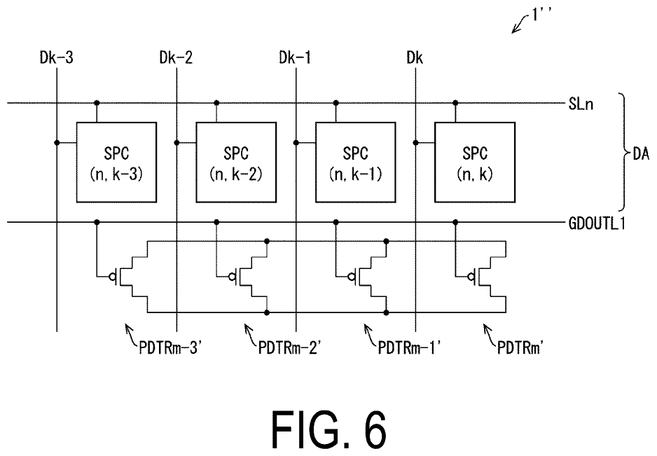

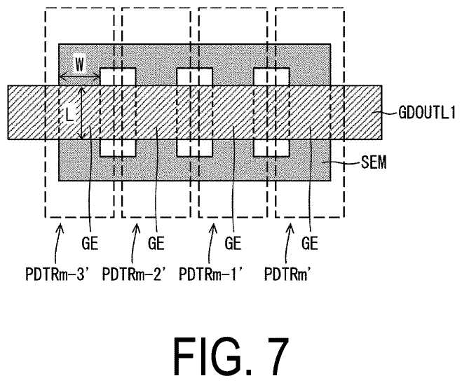

Next, a second embodiment of the disclosure will be described with reference to FIG. 6 and FIG. 7. A display device 1″ according to the present embodiment is different from the display device 1′ according to the first embodiment described above in that first dummy transistors PDTRm′ whose formation areas are further reduced are provided to the first dummy scanning signal line GDOUTL1. The other details are as described in the first embodiment. For convenience of description, members having the same functions as those illustrated in the drawings according to the first embodiment are denoted by the same reference numerals and signs, and descriptions thereof will be omitted.

FIG. 6 is a diagram illustrating a part of the display device 1″ according to the second embodiment. The display device 1″ is provided with a plurality of another type of first dummy transistors PDTRm′ each of which includes the gate electrode GE electrically connected to the first dummy scanning signal line GDOUTL1.

FIG. 7 is a diagram illustrating a schematic configuration of the first dummy transistors PDTRm′ illustrated in FIG. 6.

As illustrated in FIG. 2 and FIG. 6, each of the plurality of scanning signal lines SL1 to SLn is provided with k pixel circuits among the pixel circuits SPC (1, 1) to SPC (n, k) each of which includes the transistor (first transistor) TR2 including the gate electrode electrically connected to the corresponding scanning signal line, and in the present embodiment, the first dummy scanning signal line GDOUTL1 is provided with k first dummy transistors PDTRm′ each of which includes the gate electrode GE electrically connected to the first dummy scanning signal line GDOUTL1.

Additionally, as illustrated in FIG. 7, in two or more of the k first dummy transistors PDTRm′, in all the first dummy transistors PDTRm-3′ to PDTRm′ in the present embodiment, a part of the first dummy scanning signal line GDOUTL1 is the gate electrode GE having the length L and the width W. Each of the first dummy transistors PDTRm-3′ to PDTRm′ has the same transistor capacitance as that of the first dummy transistor PDTRm illustrated in FIG. 3 and FIG. 4 and has a smaller formation area than that of the first dummy transistor PDTRm.

Thus, according to the display device 1″ illustrated in FIG. 6, further frame narrowing of the display device 1″ can be achieved.

In the present embodiment, as described above, the case has been exemplified where the transistor capacitance of the first dummy scanning signal line GDOUTL1 (capacitance formed at the portion where the gate electrode and the semiconductor layer overlap with each other) is made substantially equal to the transistor capacitance of each of the plurality of scanning signal lines SL1 to SLn. However, the disclosure is not limited thereto, and the transistor capacitance of the first dummy scanning signal line GDOUTL1 may be made close to the transistor capacitance of each of the plurality of scanning signal lines SL1 to SLn.

### Third Embodiment

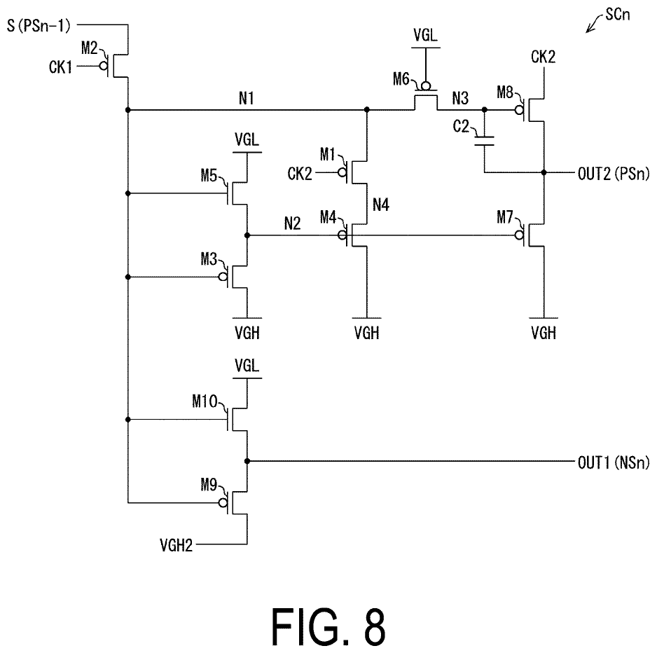

Next, a third embodiment of the disclosure will be described with reference to FIG. 8 to FIG. 10. A display device 1″′ of the present embodiment is different from the above-described first and second embodiments in that a plurality of scanning signal line sets (SL1 and SL1′, SL2 and SL2′, . . . , and SLn and SLn′) of the first scanning signal lines SL1 to SLn to which the first scanning signals PS1 to PSn are supplied and second scanning signal lines SL1′ to SLn′ to which second scanning signals NS1 to NSn are supplied are provided, and the plurality of unit circuits SC1 to SCn provided in the scanning-side drive circuit respectively output the first scanning signals PS1 to PSn and the second scanning signals NS1 to NSn. The other details are as described in the first and second embodiments. For convenience of description, members having the same functions as those illustrated in the drawings according to the first and second embodiments are denoted by the same reference numerals and signs, and descriptions thereof will be omitted.

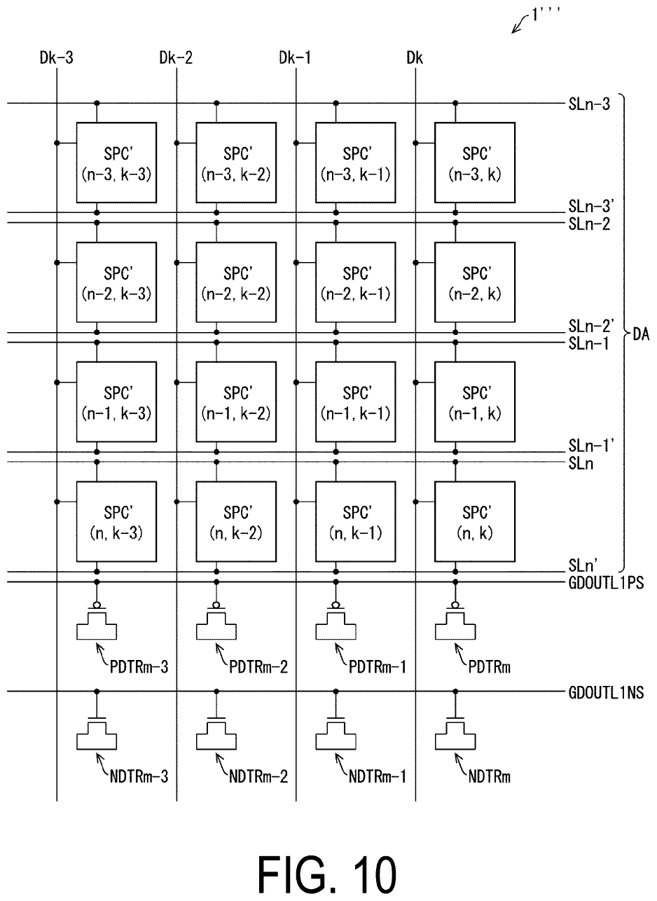

FIG. 8 is a circuit diagram illustrating the unit circuit SCn included in the scanning-side drive circuit provided in the display device 1″ according to the third embodiment illustrated in FIG. 10. Note that the configuration of the unit circuit SCn illustrated in FIG. 8 is merely an example, and the disclosure is not limited thereto.

To the unit circuit SCn illustrated in FIG. 8, a gate start pulse signal, a first gate clock signal GCK1, and a second gate clock signal GCK2 are supplied from a display control circuit (not illustrated), and a gate low voltage VGL and gate high voltages VGH and VGH2 are supplied from a power source circuit (not illustrated).

As illustrated in FIG. 8, the unit circuit SCn includes 10 transistors M1 to M10 and a single capacitor C2. The unit circuit SCn illustrated in FIG. 8 includes a first control circuit constituted by the transistor M2, a second control circuit constituted by the transistor M3 and the transistor M5, a first output circuit constituted by the transistor M9 and the transistor M10, a second output circuit constituted by the transistor M7 and the transistor M8, and a third control circuit constituted by the transistor M1, the transistor M4, and the transistor M6 and configured to control a voltage of a node N1. The transistor M1 and the transistor M4 included in the third control circuit constitute a stabilization circuit. Note that an output circuit control transistor is implemented by using the transistor M6.

As illustrated in FIG. 8, a second conduction terminal (drain electrode) of the transistor M2, a control terminal (gate electrode) of the transistor M3, a control terminal (gate electrode) of the transistor M5, a control terminal (gate electrode) of the transistor M9, and a control terminal (gate electrode) of the transistors M10 are electrically connected to each other. Further, the second conduction terminal (drain electrode) of the transistor M2 electrically connected in this manner is electrically connected to a first conduction terminal (source electrode) of the transistor M1 and a first conduction terminal (source electrode) of the transistor M6 to form the node N1. Further, a first conduction terminal (source electrode) of the transistor M2 is electrically connected to a sixth input terminal (set terminal) S for inputting the first scanning signal PSn-1 of the unit circuit SCn-1 at the immediately preceding stage, and a control terminal (gate electrode) of the transistor M2 is electrically connected to a first input terminal CK1. Further, a first conduction terminal (source electrode) of the transistor M3 is electrically connected to a fourth input terminal VGH, and a second conduction terminal (drain electrode) of the transistor M3 is electrically connected to a second conduction terminal (drain electrode) of the transistor M5. Further, a first conduction terminal (source electrode) of the transistor M5 is electrically connected to a third input terminal VGL. Further, a first conduction terminal (source electrode) of the transistor M9 is electrically connected to a fifth input terminal VGH2, and a first conduction terminal (source electrode) of the transistor M10 is electrically connected to the third input terminal VGL. Further, a second conduction terminal (drain electrode) of the transistor M9 is electrically connected to a second conduction terminal (drain electrode) of the transistor M10, the second conduction terminal (drain electrode) of the transistor M9 and the second conduction terminal (drain electrode) of the transistor M10 are electrically connected to a first output terminal OUT1, and the second scanning signal NSn is output to the second scanning signal line SLn′ via the first output terminal OUT1.

A control terminal (gate electrode) of the transistor M1 is electrically connected to a second input terminal CK2, and a second conduction terminal (drain electrode) of the transistor M1 and a second conduction terminal (drain electrode) of the transistor M4 are electrically connected to each other to form a node N4. Further, a first conduction terminal (source electrode) of the transistor M4 is electrically connected to the fourth input terminal VGH, and a control terminal (gate electrode) of the transistor M4 is electrically connected to the second conduction terminal (drain electrode) of the transistor M3 and the second conduction terminal (drain electrode) of the transistor M5 to form a node N2.

Further, a control terminal (gate electrode) of the transistor M6 is electrically connected to the third input terminal VGL, and a second conduction terminal (drain electrode) of the transistor M6 is electrically connected to a control terminal (gate electrode) of the transistor M8 and an electrode on one side of the capacitor C2 to form a node N3. Further, a first conduction terminal (source electrode) of the transistor M8 is electrically connected to the second input terminal CK2, a first conduction terminal (source electrode) of the transistor M7 is electrically connected to the fourth input terminal VGH, and a control terminal (gate electrode) of the transistor M7 is electrically connected to the control terminal (gate electrode) of the transistor M4. Further, a second conduction terminal (drain electrode) of the transistor M8, an electrode on the other side of the capacitor C2, and a second conduction terminal (drain electrode) of the transistor M7 are electrically connected to a second output terminal OUT2, and the first scanning signal PSn is output to the second scanning signal line SLn via the second output terminal OUT2.

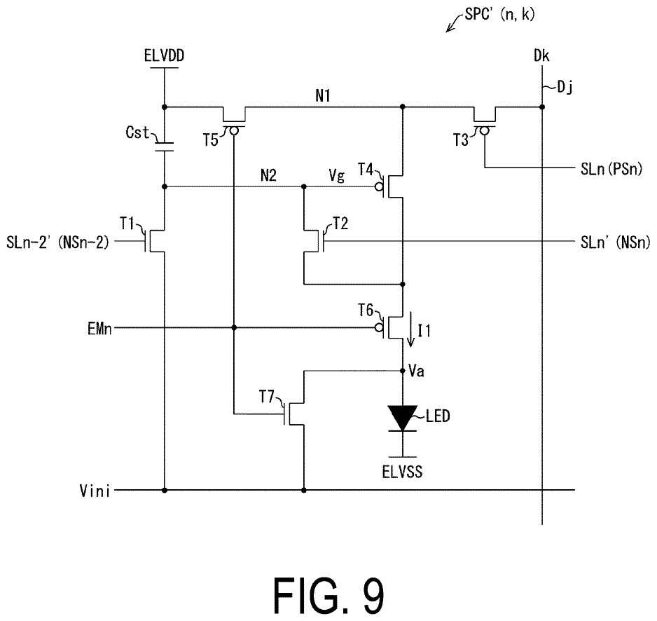

FIG. 9 is a circuit diagram illustrating a pixel circuit SPC′(n, k) provided in the display region DA of the display device 1″ according to the third embodiment illustrated in FIG. 10.

As illustrated in FIG. 9, the pixel circuit SPC′(n, k) includes one light-emitting element LED serving as the light-emitting element LED, seven transistors T1 to T7, and one holding capacitor Cst. The transistor T1 is a first initialization transistor, the transistor T2 is a threshold compensation transistor, the transistor T3 is a write control transistor, the transistor T4 is a drive transistor, the transistor T5 is a first light emission control transistor, the transistor T6 is a second light emission control transistor, and the transistor T7 is a second initialization transistor.

The transistors T1, the transistor T2, and the transistor T7 are N-type transistors. On the other hand, the remaining transistors T3 to T6 are P-type transistors. Note that the transistors T1 to T3 and the transistors T5 to T7 other than the transistor T4, which is the drive transistor, function as switching elements.

The second scanning signal NSn output from the unit circuit SCn is supplied to a gate electrode of the transistor T2 through the second scanning signal line SLn'. Further, the first scanning signal PSn output from the unit circuit SCn is supplied to a gate electrode of the transistor T3 through the first scanning signal line SLn. In addition, a light emission control signal input to a gate electrode of the transistor T6 is a signal output from a light emission control circuit (emission driver) (not illustrated) and is supplied through a light emission control line EMn. Further, the high-level power supply voltage ELVDD is supplied from a power source circuit (not illustrated) through a high-level power supply line, the low-level power supply voltage ELVSS is supplied from the power source circuit (not illustrated) through a low-level power supply voltage line, and an initialization voltage Vini is supplied from the power source circuit (not illustrated) through an initialization voltage line. Furthermore, the data signal Dj input to a source electrode of the transistor T3 is a signal output from the data-side drive circuit 52 and is supplied through the data signal line Dk.

As illustrated in FIG. 9, a gate electrode of the transistor T1 is electrically connected to the second scanning signal line SLn-2′originating from two stages before the current stage and is input with the second scanning signal NSn-2. A drain electrode of the transistor T1 is connected to an electrode on one side of the holding capacitor Cst, a gate electrode of the transistor T4, and a source electrode of the transistor T2. A source electrode of the transistor T1 is electrically connected to the initialization voltage line to which the initialization voltage Vini is supplied. The gate electrode of the transistor T2 is electrically connected to the second scanning signal line SLn′ to which the second scanning signal NSn is supplied, and a drain electrode of the transistor T2 is electrically connected to a drain electrode of the transistor T4 and a source electrode of the transistor T6, and the source electrode of the transistor T2 is electrically connected to the gate electrode of the transistor T4. The gate electrode of the transistor T3 is electrically connected to the first scanning signal line SLn to which the first scanning signal PSn is supplied, the source electrode of the transistor T3 is electrically connected to the data signal line Dk to which the data signal Dj is supplied, and a drain electrode of the transistor T3 is electrically connected to a source electrode of the transistor T4 and a drain electrode of the transistor T5. The gate electrode of the transistor T4 is electrically connected to the electrode on the one side of the holding capacitor Cst and the source electrode of the transistor T2, the source electrode of the transistor T4 is electrically connected to the drain electrode of the transistor T3 and the drain electrode of the transistor T5, and the drain electrode of the transistor T4 is electrically connected to the source electrode of the transistor T6. A gate electrode of the transistor T5 is electrically connected to the light emission control line EMn to which the light emission control signal is supplied, a source electrode of the transistor T5 is electrically connected to the high-level power supply line to which the high-level power supply voltage ELVDD is supplied, and the drain electrode of the transistor T5 is electrically connected to the drain electrode of the transistor T3 and the source electrode of the transistor T4. The gate electrode of the transistor T6 is electrically connected to the light emission control line EMn to which the light emission control signal is supplied, the source electrode of the transistor T6 is electrically connected to the drain electrode of the transistor T4, and a drain electrode of the transistor T6 is electrically connected to an anode electrode of the light-emitting element LED. A gate electrode of the transistor T7 is electrically connected to the light emission control line EMn to which the light emission control signal is supplied, a source electrode of the transistor T7 is electrically connected to the initialization voltage line to which the initialization voltage Vini is supplied, and a drain electrode of the transistor T7 is electrically connected to the anode electrode of the light-emitting element LED. An electrode on the other side of the holding capacitor Cst is electrically connected to the high-level power supply line to which the high-level power supply voltage ELVDD is supplied. A cathode electrode of the light-emitting element LED is electrically connected to the low-level power supply line to which the low-level power supply voltage ELVSS is supplied. Note that the second scanning signal NSn-2 input to the gate electrode of the transistor T1 may be the second scanning signal NSn-1. In this case, the gate electrode of the transistor T2 is electrically connected to the second scanning signal line SLn-1′ immediately before the current stage. Note that the source electrode of the transistor T4, the drain electrode of the transistor T3, and the drain electrode of the transistor T5 are electrically connected to each other to form the node N1. In addition, the source electrode of the transistor T2, the gate electrode of the transistor T4, the drain electrode of the transistor T1, and the electrode on the one side of the holding capacitor Cst are electrically connected to each other to form the node N2.

FIG. 10 is a diagram illustrating a part of the display device 1′″ according to the third embodiment.

As illustrated in FIG. 10, the plurality of scanning signal lines are constituted by a plurality of scanning signal line sets (SL1 and SL1′, SL2 and SL2′, . . . , and SLn and SLn') including the first scanning signal lines SL1 to SLn to which the first scanning signals PS1 to PSn for controlling the P-type transistors are supplied and the second scanning signal lines SL1′ to SLn′ to which the second scanning signals NS1 to NSn for controlling the N-type transistors are supplied.

A first dummy scanning signal line GDOUTL1PS to which the first scanning signal PSn+1 is supplied is provided between the display region DA and the data-side drive circuit (not illustrated) so as to intersect with the plurality of data signal lines D1 to Dk without including the pixel circuits SPC′(1, 1) to SPC′(n, k).

In addition, a second dummy scanning signal line GDOUTLINS to which the second scanning signal NSn+1 is supplied is provided between the display region DA and the data-side drive circuit (not illustrated) so as to intersect with the plurality of data signal lines D1 to Dk without including the pixel circuits SPC′(1, 1) to SPC′(n, k).

The display device 1″′ includes a first inspection terminal electrically connected to the first dummy scanning signal line GDOUTLIPS and a second inspection terminal electrically connected to the second dummy scanning signal line GDOUTLINS, although the first and second inspection terminals are not illustrated.

As illustrated in FIG. 10, each set of the plurality of scanning signal line sets (SL1 and SL1′, SL2 and SL2′, . . . , and SLn and SLn′) is provided with k pixel circuits SPC′(n, 1) to SPC′(n, k) each of which includes the first transistor (transistor T3 that is the P-type transistor illustrated in FIG. 9) including the gate electrode electrically connected to the first scanning signal line SLn and the second transistor (transistor T2 that is the N-type transistor illustrated in FIG. 9) including the gate electrode electrically connected to the second scanning signal line SLn′.

As illustrated in FIG. 10, the first dummy scanning signal line GDOUTLIPS is provided with the first dummy transistors PDTR1 to PDTRm that are k P-type transistors each of which includes the gate electrode electrically connected to the first dummy scanning signal line GDOUTLIPS, and the second dummy scanning signal line GDOUTLINS is provided with the second dummy transistors NDTR1 to NDTRm that are k N-type transistors each of which includes the gate electrode electrically connected to the second dummy scanning signal line GDOUTLINS.

In the present embodiment, the case has been exemplified where the k first dummy transistors PDTR1 to PDTRm each of which includes the gate electrode electrically connected to the first dummy scanning signal line GDOUTLIPS are provided, and the k second dummy transistors NDTR1 to NDTRm each of which includes the gate electrode electrically connected to the second dummy scanning signal line GDOUTLINS are provided. However, the disclosure is not limited thereto, and each of the number of the first dummy transistors PDTR1 to PDTRm and the number of the second dummy transistors NDTR1 to NDTRm may be one or more and k or less.

Note that the plurality of unit circuits provided in the scanning-side drive circuit of the display device 1″′ sequentially output the first scanning signals PS1 to PSn and the second scanning signals NS1 to NSn to at least one or some of the plurality of scanning signal line sets (SL1 and SL1′, SL2 and SL2′, . . . , and SLn and SLn′), for example, the plurality of scanning signal line sets (SL1 and SL1′, SL2 and SL2′, . . . , and SLn and SLn′) and a dummy scanning signal line set GDOUTLIPS and GDOUTLINS including the first dummy scanning signal line GDOUTLIPS and the second dummy scanning signal line GDOUTLINS.

In the present embodiment, each of the first dummy scanning signal line GDOUTLIPS and the second dummy scanning signal line GDOUTLINS is provided along the plurality of scanning signal lines SL1 to SLn and SL1′ to SLn′, but the disclosure is not limited thereto.

In the present embodiment, the first dummy scanning signal line GDOUTLIPS, the second dummy scanning signal line GDOUTLINS, and each of the plurality of scanning signal lines SL1 to SLn and SL1′ to SLn′ are made of the same material in the same layer, but the disclosure is not limited thereto.

In the present embodiment, the first dummy scanning signal line GDOUTLIPS, the second dummy scanning signal line GDOUTLINS, and each of the plurality of scanning signal lines SL1 to SLn and SL1′ to SLn′ are formed with the same thickness and the same line width, but the disclosure is not limited thereto.

Further, in the present embodiment, the case has been exemplified where each of the first transistor (transistor T3 that is the P-type transistor illustrated in FIG. 9) and the first dummy transistors PDTR1 to PDTRm includes a semiconductor layer made of the same material in the same shape and a gate electrode made of the same material in the same shape, and each of the second transistor (transistor T2 that is the N-type transistor illustrated in FIG. 9) and the second dummy transistors NDTR1 to NDTRm includes a semiconductor layer made of the same material in the same shape and a gate electrode made of the same material in the same shape, but the disclosure is not limited thereto. For example, regarding two or more of the k first dummy transistors PDTR1 to PDTRm, parts of the first dummy scanning signal line GDOUTLIPS may serve as the gate electrodes, and regarding two or more of the k second dummy transistors NDTR1 to NDTRm, parts of the second dummy scanning signal line GDOUTLINS may serve as the gate electrodes (see FIG. 7).

The display device 1″ has a configuration in which the plurality of scanning signal line sets (SL1 and SL1′, SL2 and SL2, . . . , and SLn and SLn′) respectively including the first scanning signal lines SL1 to SLn to which the first scanning signals PS1 to PSn are supplied and the second scanning signal lines SL1′ to SLn′ to which the second scanning signals NS1 to NSn are supplied are provided and the plurality of unit circuits SC1 to SCn provided in the scanning-side drive circuit respectively output the first scanning signals PS1 to PSn and the second scanning signals NS1 to NSn, which allows the operation check of the scanning-side drive circuit and can achieve the frame narrowing of the display device.

### Fourth Embodiment

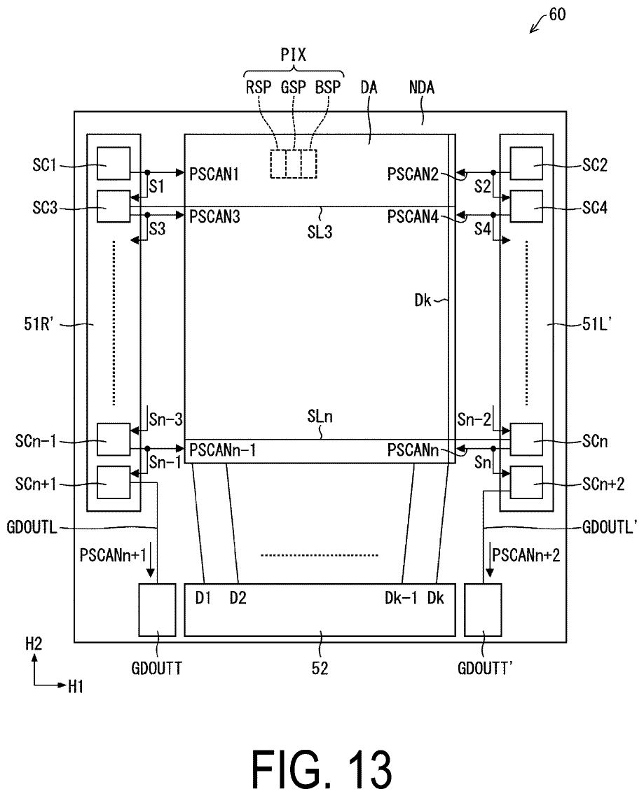

Next, a fourth embodiment of the disclosure will be described with reference to FIG. 12 and FIG. 13. A display device 10 according to the present embodiment is different from those of the first and second embodiments in that a first scanning-side drive circuit 51R′ and a second scanning-side drive circuit 51L′ are provided at both ends of the plurality of scanning signal lines SL1 to SLn, a first dummy scanning signal line GDOUTL1 and a second dummy scanning signal line GDOUTL1′, the first scanning-side drive circuit 51R′ sequentially outputs scanning signals PSCAN1, PSCAN3, . . . , and PSCANn+1 to one or some scanning signal lines of the plurality of scanning signal lines SL1 to SLn, for example, odd-numbered scanning signal lines SL1, SL3, . . . , and SLn-1 and the first dummy scanning signal line GDOUTL1, and the second scanning-side drive circuit 51L′ sequentially outputs scanning signals PSCAN2, PSCAN4, . . . , and PSCANn+2 to one or some scanning signal lines different from the above-described one or some scanning signal lines among the plurality of scanning signal lines SL1 to SLn, for example, even-numbered scanning signal lines SL2, SL4, . . . , and SLn and the second dummy scanning signal line GDOUTL1′. The other details are as described in the first and second embodiments. For convenience of description, members having the same functions as those illustrated in the drawings according to the first and second embodiments are denoted by the same reference numerals and signs, and descriptions thereof will be omitted.

FIG. 12 is a plan view illustrating a schematic configuration of the display device 10 according to the fourth embodiment.

As illustrated in FIG. 12, the display device 10 includes the first scanning-side drive circuit 51R′ and the second scanning-side drive circuit 51L′ at both ends of the plurality of scanning signal lines SL1 to SLn, the first dummy scanning signal line GDOUTL1, and the second dummy scanning signal line GDOUTL1′. The first scanning-side drive circuit 51R′ sequentially outputs the scanning signals PSCAN1, PSCAN3, . . . , and PSCANn+1 to one or some of the scanning signal lines among the plurality of scanning signal lines SL1 to SLn, for example, odd-numbered scanning signal lines SL1, SL3, ..., and SLn-1 and the first dummy scanning signal line GDOUTL 1, and the second scanning-side drive circuit 51L′ sequentially outputs the scanning signals PSCAN2, PSCAN4, ..., and PSCANn+2 to one or some scanning signal lines different from the above-described one or some scanning signal lines among the plurality of scanning signal lines SL1 to SLn, for example, even-numbered scanning signal lines SL2, SL4, . . . , and SLn and the second dummy scanning signal line GDOUTL1′.

The display device 10 is provided with the first inspection terminal GDOUTT electrically connected to the first dummy scanning signal line GDOUTL1 and the output terminal of the unit circuit SCn+1 that is for evaluating an output pulse and that is the final stage of the plurality of unit circuits SC1, SC3, . . . , and SCn+1 provided in the first scanning-side drive circuit 51R′ through the lead-out wiring line GDOUTL, and the second inspection terminal GDOUTT′ electrically connected to the second dummy scanning signal line GDOUTL1′ and the output terminal of the unit circuit SCn+2 that is for evaluating an output pulse and that is the final stage of the plurality of unit circuits SC2, SC4, . . . , and SCn+2 provided in the second scanning-side drive circuit 51L′ through the lead-out wiring line GDOUTL′.

The display device 10 illustrated in FIG. 12 is provided with no dummy pixel circuit in the frame region NDA, achieving frame narrowing. Further, since each of the first dummy scanning signal line GDOUTL1 and the second dummy scanning signal line GDOUTL1′ provided in the display device 10 has a resistance, a wiring fringe capacitance, and a cross capacitance equivalent to those of each of the plurality of scanning signal lines SL1 to SLn, when display failure occurs, the feedback for improving the operations of the first scanning-side drive circuit 51R′ and the second scanning-side drive circuit 51L′, in order to investigate the cause of the display failure in the display device 10 or to improve the display quality thereof, can be performed with high accuracy by monitoring the waveforms of the scanning signals PSCANn+1 and PSCANn+2 that are output pulses for evaluation by using the first inspection terminal GDOUTT and the second inspection terminal GDOUTT′.

Note that although not illustrated, the configuration including the first scanning-side drive circuit 51R′ and the second scanning-side drive circuit 51L′, which is employed in the present embodiment, can also be applied to the display device 1″′ according to the third embodiment described above.

FIG. 13 is a plan view illustrating a schematic configuration of a display device 60 according to a second comparative example.

The display device 60 illustrated in FIG. 13 is different from the above-described display device 10 illustrated in FIG. 12 in that the first dummy scanning signal line GDOUTL1 and the second dummy scanning signal line GDOUTL1′ are not provided.

As illustrated in FIG. 13, in the display device 60, the output terminal of the unit circuit SCn+1 that is for evaluating an output pulse and that is the final stage of the plurality of unit circuits SC1, SC3, . . . , and SCn+1 provided in the first scanning-side drive circuit 51R′ is electrically connected to the first inspection terminal GDOUTT through the lead-out wiring line GDOUTL, and the output terminal of the unit circuit SCn+2 that is for evaluating an output pulse and that is the final stage of the plurality of unit circuits SC2, SC4, . . . , and SCn+2 provided in the second scanning-side drive circuit 51L′ is electrically connected to the second inspection terminal GDOUTT′ through the lead-out wiring line GDOUTL′. Thus, although the display device 60 of the second comparative example can achieve frame narrowing of the display device 60, the waveform of the scanning signal PSCANn+1 that is an output pulse for evaluation and that is detected from the first inspection terminal GDOUTT and the waveform of the scanning signal PSCANn+2 that is an output pulse for evaluation and that is detected from the second inspection terminal GDOUTT′ are significantly different from the waveforms of the scanning signals PSCAN1 to PSCANn that can be respectively detected from the plurality of scanning signal lines SL1 to SLn, making it difficult to check the operations of the first scanning-side drive circuit 51R′ and the second scanning-side drive circuit 51L′.

### Appendix

The disclosure is not limited to the embodiments described above, and various modifications may be made within the scope of the claims. Embodiments obtained by appropriately combining technical approaches disclosed in the different embodiments also fall within the technical scope of the disclosure. Furthermore, novel technical features can be formed by combining the technical approaches disclosed in the embodiments.

INDUSTRIAL APPLICABILITY

The disclosure can be utilized for a display device.

1. A display device comprising:
a plurality of scanning signal lines;
a plurality of data signal lines each of which intersects with the plurality of scanning signal lines;
a plurality of pixel circuits provided at a plurality of locations where the scanning signal lines and the data signal lines intersect with each other;
a display region provided with the plurality of pixel circuits;
a data-side drive circuit configured to output a data signal to each of the plurality of data signal lines;
a first dummy scanning signal line provided between the display region and the data-side drive circuit, the first dummy scanning signal line intersecting with at least one or some data signal lines of the plurality of data signal lines without including any of the plurality of pixel circuits;
a first inspection terminal electrically connected to the first dummy scanning signal line; and
a first scanning-side drive circuit including a plurality of unit circuits configured to sequentially output a scanning signal to at least one or some scanning signal lines of the plurality of scanning signal lines and the first dummy scanning signal line.

2. The display device according to claim 1,
wherein the first dummy scanning signal line intersects with the plurality of data signal lines.

3. The display device according to claim 2,
wherein the first dummy scanning signal line is provided along any one of the plurality of scanning signal lines.

4. The display device according to claim 2,
wherein the first dummy scanning signal line and each of the plurality of scanning signal lines are made of the same material.

5. The display device according to claim 4,
wherein the first dummy scanning signal line and each of the plurality of scanning signal lines are formed in the same layer.

6. The display device according to claim 2,
wherein the first dummy scanning signal line and each of the plurality of scanning signal lines are formed with the same thickness and the same line width.

7. The display device according to claim 2,
wherein each of the plurality of scanning signal lines is provided with N (Nis a natural number of 2 or more) pixel circuits each of which includes a first transistor provided with a gate electrode electrically connected to the corresponding scanning signal line, and
the first dummy scanning signal line is provided with one or more and the N or less first dummy transistors each of which includes a gate electrode electrically connected to the first dummy scanning signal line.

8. The display device according to claim 7,
wherein each of the first transistor and the first dummy transistor includes a semiconductor layer made of the same material and in the same shape and the gate electrode made of the same material and in the same shape.

9. The display device according to claim 7,
wherein a part of the first dummy scanning signal line is the gate electrode in each of two or more of the N first dummy transistors.

10. The display device according to claim 7,
wherein each of the first transistor and the first dummy transistor is a P-type transistor, and
the scanning signal is a first scanning signal configured to control each of the P-type transistors.

11. The display device according to claim 7,
wherein each of the first transistor and the first dummy transistor is an N-type transistor, and
the scanning signal is a second scanning signal configured to control each of the N-type transistors.

12. The display device according to claim 7,
wherein the first scanning-side drive circuit sequentially outputs the scanning signal to each of the plurality of scanning signal lines and the first dummy scanning signal line.

13. The display device according to claim 1,
wherein the first scanning-side drive circuit sequentially outputs the scanning signal to one or some scanning signal lines of the plurality of scanning signal lines and the first dummy scanning signal line, and
the display device further includes
a second dummy scanning signal line provided between the display region and the data-side drive circuit, the second dummy scanning signal line intersecting with at least one or some data signal lines of the plurality of data signal lines without including any of the plurality of pixel circuits,
a second inspection terminal electrically connected to the second dummy scanning signal line, and
a second scanning-side drive circuit including a plurality of unit circuits configured to sequentially output the scanning signal to the second dummy scanning signal line and one or some scanning signal lines different from the one or some scanning signal lines of the plurality of scanning signal lines.

14. The display device according to claim 1,
wherein the plurality of scanning signal lines include a plurality of scanning signal line sets each of which includes a first scanning signal line configured to be supplied with a first scanning signal configured to control a P-type transistor and a second scanning signal line configured to be supplied with a second scanning signal configured to control an N-type transistor,
the display device includes
the first dummy scanning signal line intersecting with the plurality of data signal lines, the first dummy scanning signal line being configured to be supplied with the first scanning signal,
a second dummy scanning signal line provided between the display region and the data-side drive circuit, the second dummy scanning signal line intersecting with the plurality of data signal lines without including any of the plurality of pixel circuits, the second dummy scanning signal line being configured to be supplied with the second scanning signal,
a second inspection terminal electrically connected to the second dummy scanning signal line,
N, which is a natural number of 2 or more, of the pixel circuits provided in each of the plurality of scanning signal line sets, each of the N pixel circuits including a first transistor including a gate electrode electrically connected to the corresponding first scanning signal line and a second transistor including a gate electrode electrically connected to the corresponding second scanning signal line,
one or more and the N or less first dummy transistors provided at the first dummy scanning signal line, each of the one or more and the N or less first dummy transistors including a gate electrode electrically connected to the first dummy scanning signal line, and
one or more and the N or less second dummy transistors provided at the second dummy scanning signal line, each of the one or more and the N or less second dummy transistors including a gate electrode electrically connected to the second dummy scanning signal line,
each of the one or more and the N or less first dummy transistors is a P-type transistor,
each of the one or more and the N or less second dummy transistors is an N-type transistor, and
each of the plurality of unit circuits included in the first scanning-side drive circuit sequentially outputs the first scanning signal and the second scanning signal to at least one or some scanning signal line sets of the plurality of scanning signal line sets and a dummy scanning signal line set including the first dummy scanning signal line and the second dummy scanning signal line.

15. The display device according to claim 14,
wherein each of the first dummy scanning signal line and the second dummy scanning signal line is provided along any one of the plurality of scanning signal lines.

16. The display device according to claim 15,
wherein the first dummy scanning signal line, the second dummy scanning signal line, and each of the plurality of scanning signal lines are made of the same material.

17. The display device according to claim 16,
wherein the first dummy scanning signal line, the second dummy scanning signal line, and each of the plurality of scanning signal lines are formed in the same layer.

18. The display device according to claim 14,
wherein the first dummy scanning signal line, the second dummy scanning signal line, and each of the plurality of scanning signal lines are formed with the same thickness and the same line width.

19. The display device according to claim 14,
wherein each of the N first transistors and the one or more and the N or less first dummy transistors includes a semiconductor layer made of the same material and in the same shape and the gate electrode made of the same material and in the same shape, and
each of the N second transistors and the one or more and the N or less second dummy transistors includes a semiconductor layer made of the same material and in the same shape and the gate electrode made of the same material and in the same shape.

20. The display device according to claim 14,
wherein in each of two or more of the N first dummy transistors, a part of the first dummy scanning signal line is the gate electrode, and
in two or more of the N second dummy transistors, a part of the second dummy scanning signal line is the gate electrode.

21. (canceled)
